(19) United States
(12) Patent Application Publication
(10) Pub. No.: US 2002/0018217 A1
(43) Pub. Date: Feb. 14, 2002

(54) Optical critical dimension metrology system integrated into semiconductor wafer process tool

(76) Inventors: Michael Weber-Grabau, Sunnyvale, CA (US); Edric H. Tong, Sunnyvale, CA (US); Adam E. Norton, Palo Alto, CA (US); Fred E. Stanke, Cupertino, CA (US); James M. Cahill, San Jose, CA (US); Douglas E. Ruth, Sunnyvale, CA (US)

Correspondence Address: LAW OFFICE OF THOMAS SCHNECK, P.O. BOX 2-E, SAN JOSE, CA, 95109-0005, US

(21) Appl. No.: 09/927,102

(22) Filed: Aug. 10, 2001

Related U.S. Application Data
(60) Provisional application No. 60/224,571, filed on Aug. 11, 2000.

(51) Int. Cl. G01B 11/24

(52) U.S. Cl. 356/601

(57) ABSTRACT

A wafer measurement station integrated within a process tool has a scatterometry instrument for measuring patterned features on wafers. A wafer handler feeds wafers between a cassette and one or more process stations of the process tool. Wafers presented to the measurement station are held on a wafer support, which may be moveable, and a scatterometry instrument has an optical measurement system that is moveable by a stage over the wafer support. A window isolates the moveable optics from the wafer. The optical measurement system are microscope-based optics forming a low NA system. The illumination spot size at the wafer is larger than a periodicity of the patterned features, and data processing uses a scattering model to analyze the optical signature of the collected light.

### TECHNICAL FIELD

The present invention relates to semiconductor wafer processing for integrated circuit manufacture, and in particular to lithography systems, cluster tool environments, or other wafer process tools which have a robotic handler that transports wafers between the stations or modules of the tool. The invention also relates to metrology equipment for semiconductor wafers, and in particular optical measuring equipment for measuring the parameters of diffractive structures formed during lithography and further processed in other integrated circuit manufacture process steps.

### BACKGROUND ART

In semiconductor manufacturing, process tools are used to deposit, planarize, remove and pattern very thin layers of materials on semiconductor wafers in order to make electronic structures. Process tools include deposition tools for depositing uniform thin films onto semiconductor surfaces, lithography tools for applying photoresist material and creating patterns in the resist, etch tools for etching structures into the material layers, polishing tools for removing material and planarizing the wafer, and cleaning tools for removing contamination or leftover material after certain process steps. Cluster tools combine various process stations with handling systems to transfer wafers between stations. For example, lithography tracks are typically multi-station systems with their own robotic wafer handlers for transport between stations within the track. These process tools usually include various sensors, such as thermometers and gas flowmeters, to measure process parameters for controlling the manufacturing process within certain tolerances. For example, different bake stations of a lithography track may have different temperature settings at which wafers are held for different periods of time. Other sensors in a process tool determine a major change in some measurement parameter that is indicative of process completion, such as motor current end point in chemical-mechanical planarization (CMP). Steppers, which are tools for patterning photoresist, typically have an optical notch sensor for determining the location of a wafer's alignment notch relative to a reference frame of the stepper tool so that the wafer can be rotated into a predetermined orientation for properly aligned exposure of a pattern. The aforementioned sensors are incorporated into the modules or stations and form an essential part of the processing tools themselves to ensure their proper operation.

Semiconductor manufacture also makes use of inspection equipment to look for any defects or anomalies on a wafer and to report information (location, size, identity, etc.) regarding such defects or anomalies. Measuring equipment, including various optical measuring tools, such as spectroreflectometers, , beam profile reflectometers, ellipsometers, and polarimeters, are used to characterize the layers and structures formed on a wafer in terms of dimensional parameters such as layer thickness or line width. It is important to measure these parameters for process control. While such measuring equipment might report general information about an entire wafer, particularly when measuring unpatterned wafers, often the measurements need to be collected at specific predetermined locations on the wafer, particularly when measuring specific features on a patterned wafer. Because of this need to locate specific features with high precision for measurements, measuring tools typically employ pre-aligners and stages to align the wafer with respect to the optical system to allow measurement of various locations on the wafer. Many measuring tools move the wafer laterally (horizontally) while keeping the measurement system (optics) substantially stationary. This requires a footprint that is at least twice the diameter of the wafer in both lateral dimensions, in order to provide full coverage of the wafer. Other measuring tools keep the wafer stationary, and move some portion of the optics to measure various portions of the wafer. Typically, an objective lens focuses illuminating light onto the wafer and/or collects reflected light from the wafer. In some systems the same optical element is used as the objective for illumination and detection, in other systems, each function is handled separately, or only one of the two functions are performed. In any case, the objective is used here as the optics system for illuminating a portion of the wafer and for collecting light from a portion of the wafer. Hence, some measuring tools move the wafer to position the objective with respect to the wafer, and some move the wafer. In traditional semiconductor manufacturing, metrology tools, whether inspection equipment or measuring equipment, are stand-alone units. That is, they are detached from the process tools and are characterized by having their own load ports for wafer carriers, e.g. FOUPs or cassettes, generally referred to as “cassettes” below. They are sometimes even located in a different area of the fabrication facility from the process tool. In any case, individual wafers or cassettes of wafers must be transported between the process tool and the inspection or measurement tool whenever it is desired to inspect or measure a wafer following some process step. Because of the inherent delays associated with stand alone tools, inspection or measurement is normally limited to sampling a small subset of the wafers, or to sampling a small portion of each inspected wafer. Furthermore, wafers are measured only after a whole set of wafers has been processed, thus putting wafers at risk if there is a tool or process malfunction. Also, process tools are often controlled based on the results of the measurements, and long delays between processing a wafer and the availability of the measurements for that wafer reduces either the effectiveness of the control or the total rate at which wafers can be processed.

Scatterometrty is an optical measurement method that is advantageous for measuring the results of modern processes. The lateral dimensions of features on a wafer are shrinking and becoming small compared to optical wavelengths and measurement spot sizes. It has become difficult or impossible to optically image the results of such processes. Electron beams and profilometer-type instruments (e.g., atomic force microscopes, AFMs) can “image” such features but are slow and difficult to integrate into process tools. Scatterometry uses the optical characteristic of a periodic feature to determine parameters relating to lateral dimensions. Furthermore, as light penetrates below the “top” surface of the structures, scatterometry is sensitive to variations in the features with depth into the sample. For example, consider a structure that is repeating lines and spaces with a period of 0.2 microns and a nominal duty cycle of 50%. Nominally the lines and spaces would have widths of 100 nm, which is well below the resolution of an optical imaging system. However, the characteristic of light reflected from the structure will depend upon the details of the periodic structure. For example, the lines may not have vertical walls, and variations in the sidewall angle will cause variations of the optical characteristics. Scatterometry utilizes some model of the optical characteristics of the periodic feature which has parameters. In scatterometry, the parameters of the modelare varied until there is a best match between measured and modeled characteristics. The parameters of the model that produce the best match are regarded as the measured parameters. It is clear that the measured parameters can be transformed mathematically to a form that is easier to use or more closely related to the process.

The optical characteristic used for scatterometry is measurable and has one or more independent parameters so that the whole collection of independent parameters forms a plurality. Most measurable optical characteristics are related to the intensity of light that has interacted with a structure. Examples are the intensity of reflected light for a reflectometer, and the ellipsometric parameters psi and delta for an ellipsometer. Examples of independent parameters are wavelength and incidence angle. Other independent parameters are possible, for example azimuthal angle measured relative to some pattern in the structure of interest, or polarization state. In general, an independent parameter is any characteristic of the measurement system which is controlled and which affects the optical characteristic of the wafer.

The model used by scatterometry may be either physical or theoretical. In the former case, the “model” consists of measurements of samples with known parameters. Ideally the measurements are made with an instrument that is the same or similar to the measurement tool under discussion. Preferably, the model may be theoretical, and include the optical properties of the instrument as well as some mathematical representation of light interacting with structures having variable parameters. It also includes the optical properties of the material (index and absorbance) as appropriate, e.g., as functions of wavelength.

The theoretical model typically comprises calculations of electromagnetic interactions that are exact for some model of the structure on the wafer. Typically, the geometric model of the structure is an approximation to a perceived possible geometric model. For example, the profile of the periodic structure is expected to be smooth but the actual geometric model has a “staircase” approximation to allow rigorous coupled mode calculations to be performed. Such calculations are often time consuming. In order to optimize the speed of measurement one can perform some portion of the calculation in advance of the measurements and store the results in a database. In a simple case, one picks the structure parameters and fixes the possible values for each parameter based on a range and discretization. Then optical characteristics for each combination of parameter values is calculated and stored in a database. At measurement time, each characteristic is compared to a measured characteristic, and the parameters associated with the theoretical charcteristic that best matches the measured characteristic are chosen as the measured parameters. For example, the measured profile has the profile parameters of the best fit model characteristic. Alternatively, the measured critical dimension of the lines is derived from the parameterized profile, e.g., the width of the line at 20% of its height. A disadvantage of using a library is that the discretization of the parameters is apparent in the measurements and may lead to “discretization noise” in measurements of a physically smoothly varying parameter.

An alternative to the library approach mentioned above, is a “library-less” method where electromagnetic calculations are performed at measurement time. A disadvantage to this approach is that there is a tradeoff between the measurement time (which includes calculation time) and model complexity. For example, the staircase approximation mentioned above cannot have many steps in order to finish in an acceptable time, and may not fit the actual profile very well, or parameterization of its characteristic may not have the degrees of freedom needed to match the measured characteristics.

Scatterometry is sensitive to overlay registration. A substructure with a lateral geometry of a certain period is produced at one state of the wafer. Later, as the structures on the wafer have been built up, another sub-structure of the same period may be placed directly over the first substructure. The second substructure may consist of developed photoresist, and the first substructure of an etched lower layer of the wafer, for example, etched gate contacts, isolation trenchs, or metallic wiring. The two substructures now form a single structure with a period that will have an optical characteristic, since they occupy the same lateral region. The alignment between the two substructures will generally affect the (total) structure's optical characteristic, and can be represented by parameters in the model characteristic. Thus scatterometry can measure overlay, by having a properly parameterized model, and returning the value of the parameter(s) related to alignment of the sub-structures. Overlay is a very critical measurement since it is a measure of how well the stepper was able to align and then print one pattern over another. This parameter is tightly controlled because it can have a very significant bearing on how densely features can be packed together as well as the overall performance of the semiconductor device. Thus the same instrument is capable of measuring several critical lithography parameters using scatterometry: overlay, profiles, critical dimensions, line edge roughness, contact hole shapes and whether they are open or not.

Scatterometry can also be applied to make measurements of critical parameters after etch, CMP and Clean. For example, after metal CMP scatterometry can be used to determine the amount of oxide erosion or remaining metal in a periodic array consisting of alternating oxide and metal areas, where the lateral dimensions are significantly smaller than the spot size and comparable to the wavelength of light used. If there is (undesirable) metal or other film residue left on these periodic structures, it is possible to detect their presence, again by comparing the measured optical characteristic data to appropriate modeled characteristics.

The structures inspected with scatterometry are typically substantially periodic, but not exactly so. Defects in the materials and process applied to the wafer lead to non-periodic features on structures that are intended to be periodic, for example lines are not perfectly straight and have “roughness”.

Substantially periodic structures typically reflect light into various diffraction orders, as is well known in the art. For finer structures, or longer wavelengths or higher orders, a diffracted order may be non-propagating or evanescent, and not detectable directly. However, such non-propagating orders take energy away from propagating orders, and so may affect the characteristic (measured portion) of the propagating orders. Scatterometry is often performed with substantially only the 0^{th} diffracted order contributing to the measured characteristics, since it never becomes evanescent. In European patent application publication EP 0 973 068 A2 (Nova Measuring Instruments), Cohen et al. describe a measuring tool that is integrated into a lithography track, or alternatively as one of the components of a cluster tool. The measuring tool is a spectrophotometer for measuring thickness, absorption coefficient and refractive index of the photoresist, and substrate reflectivity. Measurement occurs after the resist coating step, but prior to the exposure and development steps. The measurement results are used in forward control of the exposure tool to achieve an optimum exposure dose. However, neither critical dimension metrology of the patterned structures nor overlay is integrated into this phototrack and would still typically be conducted after the development step using a stand-alone machine.

In European patent application publication EP 0 973 069 A2 (Nova Measuring Instruments), Dishon et al. describe a lithotrack apparatus into which a measuring station is integrated, using the same robotic wafer handler. The measurement instrument consists of a microscope with a high magnification high NA image channel for measuring critical dimension (CD) errors, etc. The wafer is held stationary while in the measuring station and the station has a movable optical head on an x-y-z stage. The optical head and movable stage are in an enclosure with a transparent optical window in order to protect the wafer from contamination. Measurement occurs at the end of lithographic processing before being unloaded to a cassette.

### DISCLOSURE OF THE INVENTION

The object is met by a wafer measurement system and method in which an optical scatterometry measurement station is integrated into a wafer process tool. The measurement station makes use of the the robotic wafer handler mechanism of the process tool, for wafer transfer within the process tool between stations or modules including the receipt by the measurement station of wafers to be measured. Wafers can thus be transferred directly from a processing station of the process tool to the measurement station without first having to leave the process tool. Thus it is convenient to measure the process results on individual wafers before all the wafers in the set have been processed. At the time of measurement, processing of a wafer may be complete, so that the wafer is then transferred by the wafer handler to a carrier or cassette station associated with the process tool. Alternately, wafers may be measured at an intermediate stage of processing with subsequent processing depending on the results of the measurements. When processed by other modules of the process tool, the process parameters may depend upon the measurement result. In some cases the wafer may be reworked by the same process module if the result of an earlier process is found by the measurement to be inadequate. Since measurement results are available more quickly than with stand alone metrology, equipment efficiency is improved and closed loop process control is now possible.

The measurement station comprising an optical instrument that obtains data for an optical characteristic of a diffractive pattern on a wafer. The instrument preferably uses a movable optical system to position the measurement location on the wafer with minimal motion of the wafer, to allow the minimum footprint of the measurement station. A wafer support preferably holds the wafer in a fixed translational (x,y) position, while the optical head moves in a plane parallel to the wafer to a plurality of specified locations over the wafer,. In a preferred embodiment (r-theta), the wafer rotates (theta, with substantially no translation), and the optical head translates in one lateral dimension substantially from the center to the edge of the wafer, r. In an alternative embodiment, some translation of the wafer or optics perpendicular to r is allowed to simplify the algorithms for positioning the optics relative to the wafer. The optical instrument may be a spectro-reflectometer or a beam profile reflectometer, an ellipsometer, a polarmeter, or any optical instrument capable of measuring an optical characteristic of sites on the wafer as a function of independent optical parameters. Possible independent optical parameters include polar angle of incidence, polar angle of reflection, direction of incidence (with respect to patterns on the wafer), direction of reflection, wavelength, incident polarization, reflected polarization. “Reflection” is used here and throughout to signify either reflection from or transmission through a sample (wafer) of the incident light. The preferred embodiment is a substantially normal incidence reflectometer with wavelength as the independent optical parameter. A light source provides a light beam that is directed through the head onto the patterned features of the wafer surface. The optical system typically includes an objective lens for focusing the light beam to a spot on the wafer. The objective lens may also act as a light collector for light reflected from the wafer. The optical system may have a pinhole associated with the light collection path, which maintains a fixed optical relationship to the objective lens as the optical system moves. In any case, light collected by the optical optical system is detected and analyzed to obtain a measure of the parameters of interest of the pattern features in the wafer. Analysis of the data obtained from the light detector preferably involves comparison of the measured characteristic optical signatures from the wafer surface features with a database of signatures stored in a memory, each of which is associated with known critical dimensions of pattern features.

### BRIEF DESCRIPTION OF THE DRAWINGS

FIG. 1 is a schematic plan view of a process tool integrating an optical scatterometry measurement station (IMS) in accord with the present invention.

FIG. 2 is a schematic side view of an optical measurement station suitable for scatterometry and for integration with the process tool of FIG. 1.

FIG. 3 is a perspective view showing details of the measurement optics for another measurement station suitable for scatterometry and for integration with the process tool different from the station of FIG. 2.

FIG. 4 is a schematic side view showing details of components used in an alternate embodiment of the measurement optics in FIG. 3.

FIG. 5 is a schematic side view showing the position of components used in another alternate embodiment of the measurement optics in FIG. 3.

### BEST MODE FOR CARRYING OUT THE INVENTION

With reference to FIG. 1, a process tool 11 includes a plurality of processing stations (PS) 13, one or more cassette stations (CS) 15, and a shared robotic wafer handling and transfer mechanism (RH) 17. The robotic handler 17 unloads wafers from the cassette stations 15 and transports the wafers in a specified sequence between the processing stations 13 for carrying out various process steps. The processing stations 13 can be any of a wise variety of tools used in semiconductor circuit manufacturing, including deposition tools, lithography tools, etch tools, bake tools, planarizing or polishing tools and cleaning tools. After completion of the last process step, the robotic handler 17 transports a wafer from the last processing station 13 back to a cassette stations 15, which may or may not be the same station that the wafer was unloaded from.

In the present invention the process tool 11 also includes one ore more integrated measurement stations (IMS) 19. The measurement station 19 is constrained by the size standards in order to permit it to be mounted in the process tool 11. A measurement station 21 might also replace a cassette load station 15, which can have even tighter size constraints than the processing stations 13. The measurement station(s) 19 or 21 share the same robotic handler 17 as the rest of the process tool 11. The robotic handler can comprise several robots, for moving the wafer both globally and locally within the process tool 11. At any time in the manufacturing process after completion of any of one or more process steps in a processing station 13, the handler 17 may transport a wafer to a measurement station 19 or 21 for carrying out a specified measurement. Measurement of a wafer may be done at the completion of all process steps prior to being returned to a cassette station 15 or at some intermediate stage in the manufacturing process. Subsequent process steps may depend upon the measurement results. Also, the processing of subsequent wafers may depend upon the measurement results.

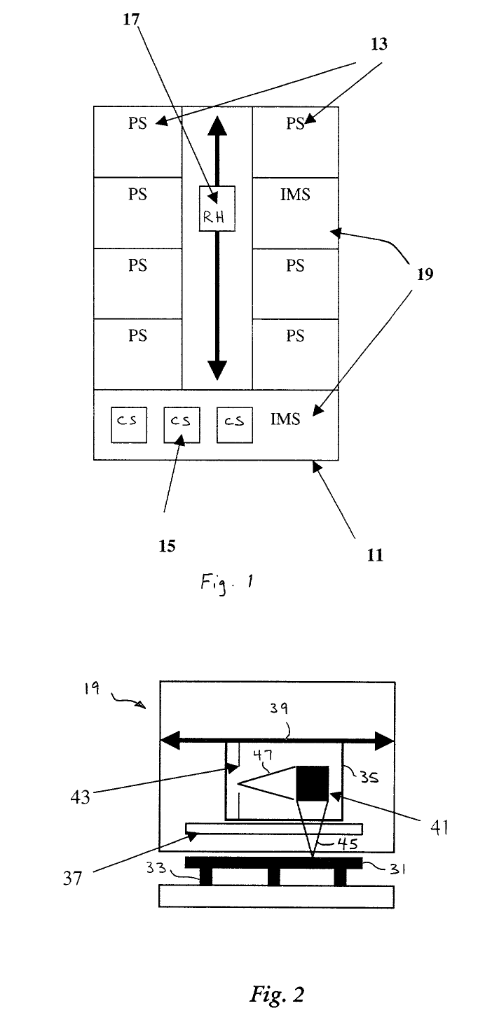

With reference to a preferred embodiment in FIG. 2, an integrated measurement station 19 or 21 in the present invention provides an optical instrument suitable for scatterometry, e.g., for measuring parameters of fine patterned features on a wafer, such as line width, step height, sidewall angle or line profile. However, the process tool 11 in FIG. 1 might also include other kinds of measurement and inspection stations, such as for characterizing unpatterned wafers (e.g., resist coating thickness) or measuring electrical characteristics.

In the preferred optical measurement station 19 in FIG. 2, a wafer 31 is mounted on a three-point wafer support 33 and objective 41 preferably moves laterally in at least one dimension. The support 33 preferably holds the wafer 31 stationary once it has been placed underneath the measurement optics. A three-point support 33 is preferred because it provides minimum wafer contact. Since the wafer does not move in this preferred embodiment, no interlocks are necessary, thereby preventing inadvertent collisions between the process tool wafer transfer mechanism and the wafer support mechanisms.

Alternatively, the three-point support 33 may be replaced with either an edge support, a wafer chuck or a multi-pin chuck. In the edge support, the wafer 31 is centered and supported by its outside edge. In the wafer chuck, the wafer 31 rests flat on a platen. In a multi-pin chuck the wafer rests on 3 or more pins, and vacuum is applied to the pins to hold the wafer firmly, but with less contact area than a vacuum chuck. All alternatives allow rotation and/or notch alignment of the wafer 31 after it has been placed into the station. While the chuck potentially does a better job at keeping the wafer flat and therefore always in focus relative to the measurement optics, thereby improving throughput since autofocusing time is minimized, it requires lift pins for robot and effector clearance between the chuck and the handler and backside contact with the platen provides an opportunity for cross-contamination.

The measurement optics 35 are physically isolated from the wafer 31 by an enclosure 36 with a transparent (e.g., fused silica) window 37. The window 37 protects the wafer surface from contamination from any particles or outgassing originating in the optics assembly above. Likewise, the window 37 protects the optics from contamination originating from the wafer 31, such as vapors, or an adverse environment the wafer 31 may be located in, such as chemicals, liquids, gases or vacuum.

The optics assembly in the enclosure 36 includes a movable measurement optical system 35 driven by a moving stage 39. The purpose of the stage system 39 is to move the optics over the wafer to a location selected for measurement. Accurate positioning of the objective 41 with respect to the wafer is important since the wafer features to be measured are small and in specific locations. In a preferred embodiment, the stage system 39 consists of x and y stages for moving the objective in two orthogonal lateral directions parallel to the wafer surface. Alternatively, the objective could be moved by a single stage in one direction (a radial direction) only, while the wafer is rotated, for examples, by an edge support, a pin-chuck or a platen.—A variety of such stage systems 39 are available within the size constraints imposed by the process tools. Moving the optical measurement system 35 avoids having to translate the wafer, which would require a bigger footprint, while still providing full wafer coverage.

The movable optical system 35 includes at least objective lens 41 and pinhole 43 in fixed relationship to each other. The objective lens 41 is in both the incident and reflected light paths. The objective lens 41 focuses incident light 45 through the window 45 onto the structured surface of the wafer 31. The objective lens 41 also collects the light reflected from the wafer and focuses some of this collected light 47 onto the pinhole 43. The pinhole 43 samples the light 47 for transmission to a spectroscopic detection system (not shown in FIG. 2), elements of which may or may not be part of the movable optical system 35.

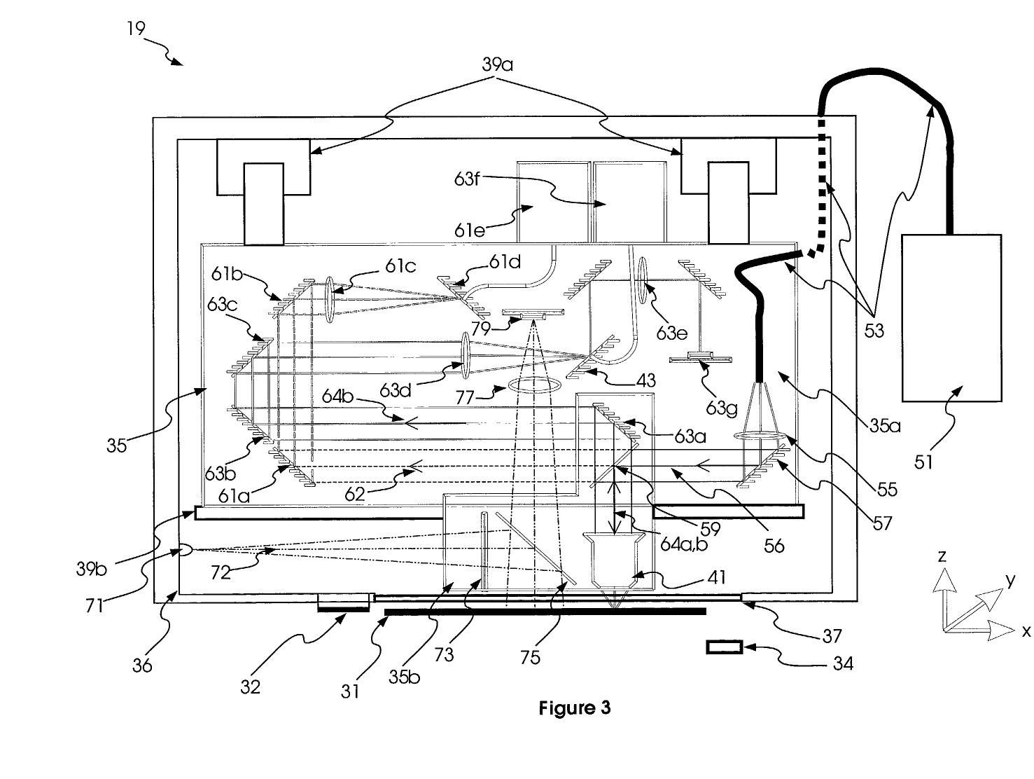

FIG. 3 shows further details of another preferred optical measurement instrument.

In this case, some of the optics on support 35a move only in y on ystages 39a which are attached to the top of enclosure 36. Support 35b and its optics move in y with support 35a, but also move in x on xstages 39b.

Thus in this embodiment the objective 41 moves in x and y, and the pinhole in mirror 43 moves only in y, so the two are not in a fixed relationship. In this embodiment light from broadband light source 51 is conveyed to optical measurement station 19 by fiber 53. A broadband light source 51 provides electromagnetic radiation (light, both visible and ultraviolet) at a multiplicity of wavelengths, preferably in a 240 nm-1000 nm wavelength range. Collimator 55 collects and substantially collimates light from fiber 53. Mirror 57 deflects the collimated beam towards the x-y movable optics. Beam splitter 59 splits collimated beam 56 into monitor beam 62 and sample beam 64. Monitor beam 62 is deflected by mirrors 61a and 61b so that it can be focused by monitor lens 61c onto monitor pin-hole mirror 61d. Some of beam 61 is sampled by the pinhole and passes through a fiber to monitor spectrometer 61e where its spectrum is recorded. Objective 41 focuses the downward propagating illuminating light 64a onto wafer 31, through window 37 held by frame 36, and collects reflected sample beam 64b. Transparent window 37 is attached to the bottom of the enclosure 36 over wafer 31. Sample beam 64 passes through beam splitter 59 and is deflected by mirrors 63a, 63b and 63c. Sample lens 63d focuses sample beam 64b onto sample pinhole mirror 43, which samples part of sample beam and passes it through a fiber to spectrometer 61e. Sample pinhole mirror 43 reflects the remainder of sample beam 64 so that it can be focused by imaging lens 63e onto small field of view camera 63g.

Reference reflector 32 is in the range of motion of the objective but not obscuring the wafer. It has a stable reflectivity, and the effective reflecting surface has nominally the same z position as the top of wafer 31.

Absorber 34 is designed to reflect nearly zero light when the objective is placed over it. The absorber could be any number of things including: a reasonably black surface far from focus, two black surfaces in a V shape, a stacked array of razor blades, or a roughened black-painted surface. The best design is two or three pieces of black glass arranged so the specular reflection from one falls on the next. With the objective placed over the absorber is possible to measure the signal due to unwanted stray light in the optics so that this quantity can later be subtracted from each measurement. Preferably, the absorber 34 is positioned so the objective 41 views it through the window 37 or, if this is not mechanically feasible, a second window (not shown) that has the same reflectance as window 37. In order to view a large patch near the center of the wafer, support 35b moves to the postion shown. LED 71 emits large-field-of-view (LFOV) illumination 72. Fresnel lens 73 collects LFOV illumination 72 and directs it towards LFOV beam splitter 59. LFOV beam splitter 75 directs some illumination onto wafer 31 and allows some light reflected by the wafer to pass through LFOV lens 77 which focuses onto LFOV camera 79. The LFOV is at least 2 mm square.

Spectrometers 61e and 63f, cameras 79 and 63g, x nd ^{y} motors (not shown) associated with stages 39a and 39b, etc are electrically connected to the measurement processor (not shown). The processor digitizes spectra, drives motors, and generally controls the system to collect characteristics at predetermined locations on wafer 31.

After wafer 35 arrives, LFOV camera 79 allows the determination of the position of the wafer with stages 39 in the position shown. After that, stages 39 allow movement of the objective to pattern locations and measurement sites, where optical characteristics are recorded with the help of spectrometers 61e and 63f.

Alternatively, metrology station 19 includes autofocus for objective 41.

Alternatively, there is also a notch viewing system like that provided in other process tool modules for determining the precise wafer orientation and position relative to the reflectometer instrument's objective lens 41. The orientation of the pattern in the LFOV image can be determined using pattern recognition software, such as PatMax by Cognex Corporation. The location of the center of a wafer is preferably determined by moving the SFOV so as to image part or all of the curved edge of the wafer, using the images, so obtained to calculate the center position. Further, calibration marks may be incorporated into the wafer support (not shown in FIG. 3) to provide a reference for use in focusing when the wafer is not present. For example, the very edge of the top of one or more of the support points in the 3-point wafer support can be used to determine the distance to the measurement optics. This information, when combined with wafer thickness information, can be used to calculate the location of the wafer surface and control adjustment of a 2-stage associated with either in the optics assembly or the wafer support until the wafer is in focus.

The optical measurement station would also include a data acquisition and processing system, some or all of which might be located outside of the process tool module. In such a system, the measured reflected intensity spectrum from a spectroreflectometer of pattern features on the wafer or other like data from another type of optical measurement, such as, beam profile reflectometry, ellipsometry or polarimetry data, may be digitized, possibly modified computationally, e.g., for calibration, to become a measured characteristic used for analysis. Analysis may include searching a library of precomputed characteristics to find a best match or any of the other scatterometry techniques described above. The use of two measurement channels, one being a monitor channel 61 and the other being the sample channel 63, and the use of monolithic spectrometers 61e and 63f compensate, e.g., for fluctuations or changes in the light source and for temperature induced drifts. The objective lens system 41 is part of an optical system with a low numerical aperture (0.1 or less) to simplify the calculation of optical characteristics based on a single diffracted order, and so that the system is less sensitive to focus when observing the topographic patterned surface of the wafer and to compensate for any wafer shapes deviations while on the three-point support. Alternatively, an autofocus system may adjust the distance between the objective and wafer.

Beamsplitter 59 is a inconel-coated fused silica plate. Alternatively, a multilayer dielectric or metal/dielectric hybrid coating may be used but with reduced efficiency over the combined UV and visible wavelength range. These other coatings also have the problem that they introduce more unwanted polarization in the beam. A cube beamsplitter may be used in place of the plate, but the plate has a particular advantage for UV systems since it uses no optical cement (as in the cube) that may deteriorate in UV light.

In some cases, the low NA desired for scatterometry may cause the area on the sample from which light is collected to become larger due to diffraction effects. There are two possible improvements to the optics in FIG. 3 that can be made. One is to make the system a confocal microscope-based system. Another is to place an apodizer near the aperture stop of the objective. These two improvements may be used together or separately.

In general, a confocal microscope projects a pinhole onto the sample being inspected or measured, the combined image of the sample and pinhole are then projected onto a second pinhole thereby allowing the microscope to collect light from an area on the sample smaller than diffraction would otherwise allow.

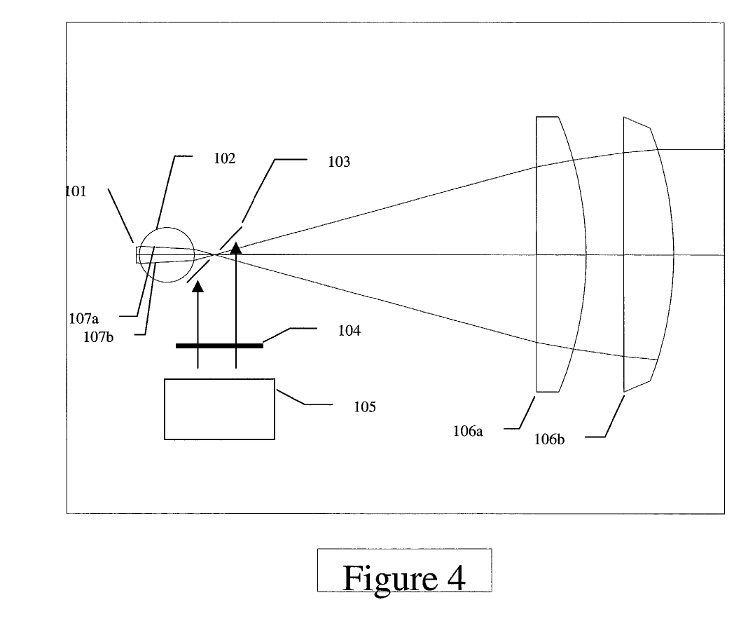

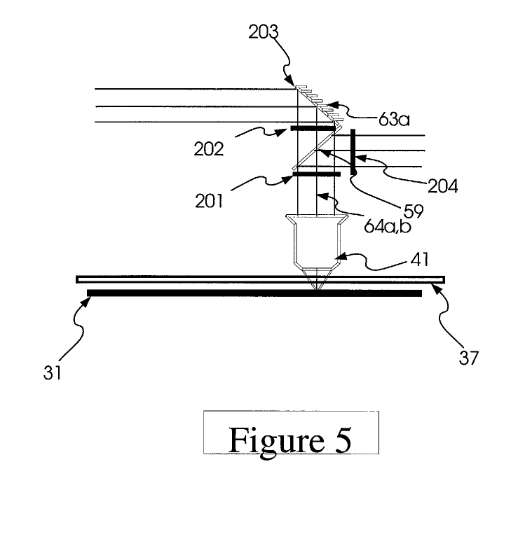

FIG. 4 is detailed view of components that replace lens 55 in FIG. 3 to convert the system in FIG. 3 to a confocal microscope-based system. In FIGS. 3 and 4, parallel rays 107a and 107b that exit fiber 101 are focused to reflective pinhole 103 by ball lens 102. Rays 107a and 107b are then collimated by lenses 106a and 106b. The rays 107a and 107b are then focused on the wafer 31 forming an image of the pinhole 103 on wafer 31. The image of the pinhole 103 on the wafer 31 should be slightly larger than the measurement spot used to collect light determined by the size of pinhole 43 and the magnification of the lens system comprising objective 41 and lens 63d. Reducing the size of pinhole 103 has the desired effect of reducing the spotsize, but it also has the undesired effect of decreasing the depth of focus on the wafer 31. The size is chosen to balance these two effects.

Another consequence of the pinhole 103 is that it blocks the light illuminating the rest of the field of view that is used for pattern recognition. To provide field illumination, the pinhole 103 is etched in a reflective coating that can allow light from field illumination optics 105 to reflect off its face. The shutter 104 is open when the field must be illuminated for pattern recognition and closed for measurements. The field illumination optics 105 are arranged such that its exit pupil (not shown) is imaged near the wafer plane 31, and the light source (not shown) is imaged just after mirror 57.

An apodizer is an aperture with a gradually varying transmission that serves to remove the diffraction rings from the point spread function and reduces the effective spot size of the instrument. Ideally, the apodizer should produce a Gaussian intensity profile in the transmitted beam, but in practice any smooth profile that varies from dark to light will nearly as good. The goal is to eliminate as much as possible of the high end of the spatial frequency spectrum of the profile. The apodizer can also be a graded reflective surface.

To avoid or reduce vignetting, the apodizer should be placed at or near the aperture stop for the optical system. FIG. 4 is a detail from FIG. 3 showing four possible positions for the apodizer.

In FIG. 4, position 101 is closest to the objective stop, but it does not introduce some of the advantages of other positions. Since the light travels through the apodizer twice at this point, the optical density profile has to be multiplied by 0.5 compared to the other positions.

Position 102 is also close to the objective aperture, but it also reduces the sensitivity of the system to sample tilt. This is true whenever the stops for illumination and collection beams have slightly different sizes. Position 102 is also to best location for an ordinary system aperture stop to reduce the collected NA from the wafer.

Position 103 is the best place for a reflective apodizer. Since it is at 45 deg. it must be elongated in one direction.

Position 104 is in many ways similar to position 102, but is probably less desirable because it places a moving aperture in the monitor channel path (not shown above) that may affect its reading.

In the preferred embodiment, the processor calculates the optical characteristic from optical spectra, and then selects a set of measurement parameters from a library for the structure of interest based on the best fit between the measured characteristic and a model characteristic in the library. The library has been calculated before the measurements are made on the desired wafer, with appropriate parameters.

With the measured spectrum as the basis of the optical characteristic, the best match being associated with a set of one or more optical and/or geometric parameters (width, height, profile, refractive index, etc.) of the structure on the illuminated area of the wafer. Once such parameters have been determined, and possibly modified or transformed, these measurement results can be used for process control of subsequent steps on that wafer by the processing stations in the process tool or for process control of any of the preceding process steps for subsequent wafers or for fault detection to avoid wasted processing or wasted wafers. Adjustments to process tool recipe parameter are calculated based on a model of the process and deviations of the measured parameters from the target parameters. Integration of the measurement instrument into the process tool speeds wafer manufacture and allows short loop wafer process control.

In FIG. 3 the coordinate axes x, y and z, are shown for convenience. In practice the axes may be rotated to a convenient position. While a preferred embodiment has been described in detail, many alternative embodiments are possible within the scope of the current invention.

1. A wafer measurement system for use within a wafer process tool, comprising:
a wafer handler associated with the wafer process tool for feeding wafers between a cassette and any one or more of a plurality of stations of the wafer process tool;
a wafer measurement station forming one of the stations of the wafer process tool, the measurement station having a wafer support in communication with the wafer handler, the measurement station also having therein an optical measurement system forming a scatterometry instrument that is moveable by a stage to specified locations over the wafer support, the optical measurement system optically coupled to a light source to direct a light beam as a spot onto patterned features of a wafer surface on the wafer support, wherein the light beam is characterized by a spot size that is larger at the wafer surface than a periodicity of the patterned features, the head also having a light collector associated with a detector whereby illuminated features on the wafer yield characteristic optical signatures with independent optical parameters in the signatures including one or more of wavelength, incidence angle, and altitude and azimuthal collection angles; and
a data processor analyzing the characteristic signatures of a wafer using a scattering model for possible periodic structures on a wafer to obtain a measure of the patterned features on the wafer so that a process carried out by the wafer process tool can be analyzed.

2. The apparatus of claim 1 wherein the optical measurement system includes an objective lens imaging light from a spot on the wafer.

3. The apparatus of claim 2 wherein the optical measurement system forms a low numerical aperture (NA) system with an NA<0.4 for optimum scatterometry.

4. The apparatus of claim 2 wherein the optical measurement system includes a pinhole aperture associated with the light collector receiving light from the wafer, with the objective lens imaging light traveling in opposite directions, the pinhole aperture maintaining a fixed optical relationship to the objective lens as it moves.

5. The apparatus of claim 2 wherein the movable optical measurement system comprises a confocal microscope-based measurement system.

6. The apparatus of claim 2 wherein the measurement system further includes an apodizer located near the objective aperture stop of the microscope-based system.

7. The apparatus of claim 2 wherein illumination and collection paths of the microscope-based system separate at an inconel plate beamsplitter.

8. The apparatus of claim 1 wherein the light beam incident on the wafer is substantially unpolarized and the optical measurement system is substantially polarization insensitive.

9. The apparatus of claim 1 wherein the wafer handler feeds wafers into the wafer measurement station with a unspecified wafer orientation relative to the optical measurement system.

10. The apparatus of claim 1 wherein the optical measurement head directs the light beam at normal incidence onto the wafer surface.

11. The apparatus of claim 1 wherein the measure of patterned features obtained by the data processor includes at least one dimension of lateral or vertical geometric structure of features on the wafer.

12. The apparatus of claim 11 wherein the measure of patterned features include line width and profile of features of the wafer.

13. The apparatus of claim 12 wherein the profile of pattern features is characterized by a feature height or depth that may be variable with lateral position across the features, the scattering model used by the data processor taking such variable feature height or depth dependence on lateral position into account.

14. The apparatus of claim 1 wherein the measure of patterned features obtained by the data processor includes any one or more of: overlay, erosion, residue, trench depth, film thickness, contact hole shape and size, open or closed state of contacts, and line edge roughness.

15. The apparatus of claim 1 wherein the measurement station includes an optical absorber positioned to one side of the wafer support to provide a reference zero reflectance measure for bright background measurement.

16. The apparatus of claim 1 further comprising an x-y stage driving the optical measurement system, the wafer support holding the wafer stationary within the wafer measurement station.

17. The apparatus of claim 1 wherein the wafer support is capable of moving a wafer in at least one dimension.

18. The apparatus of claim 17 wherein the wafer support is rotatable to any of a plurality of angular orientations (q) of wafer features relative to the measurement head without (x,y) translation of the wafer, and a linear stage drives the optical measurement system relative to a radial position (r) of the wafer.

19. The apparatus of claim 17 wherein the wafer support provides (x,y) translation of a wafer.

20. The apparatus of claim 17 wherein the wafer support is tiltable to any of a plurality of incidence angles of said beam onto said wafer surface.

21. The apparatus of claim 1 wherein the wafer support provides at least a 3-pin wafer contact.

22. The apparatus of claim 1 wherein the wafer support comprises a vacuum chuck.

23. The apparatus of claim 1 wherein the measurement station includes a window located between the measurement system and the wafer support to isolate a wafer from potential contamination by the movable optical system.

24. The apparatus of claim 23 wherein the measurement station is otherwise unsealed from the process tool environment.

25. The apparatus of claim 23 wherein the window is removable to permit cleaning and maintenance of the optical measurement system and a stage for moving the system.

26. A scatterometry instrument integrated within a wafer measurement station that forms one station of wafer process tool, the process tool having a wafer handler associated therewith feeding wafers between a cassette and one or more of a plurality of stations of the process tool, the wafer measurement station having, in addition to the spectrometry instrument, a wafer support with a capacity for locating a wafer at a measurement position, wherein the scatterometry instrument comprises:
a movable stage;
an optical measurement system mounted on said stage for movement by said stage to one or more specified locations over a wafer held by a stationary or movable wafer support in the measurement position, the measurement system being in optical communication with a light source for directing a light beam as a spot onto patterned features of a wafer on the wafer support, wherein the light beam is characterized by a spot size that is larger at the wafer surface than a periodicity of the patterned features, the measurement system having collection optics associated with a detector for collecting and detecting light scattered from the portion of the wafer illuminated by the light beam, whereby features on the wafer yield characteristic optical signatures with independent optical parameters of the signatures including one or more of wavelength, incidence angle, and altitude and azimuthal collection angles; and
a data processor in communication with the detector, the data processor analyzing the characteristic optical signatures using a scattering model for possible periodic structures on a wafer to obtain a measure of the patterned features on the wafer such that a process carried out by the wafer process tool can be analyzed.

27. The instrument of claim 26 wherein the optical measurement system directs the light beam at normal incidence onto the wafer.

28. The instrument of claim 26 wherein the collection optics of the measurement system includes an objective lens positioned to image light scattered from a spot on the wafer.

29. The instrument of claim 28 wherein the measurement system forms a low numerical aperture (NA) optical system with NA<0.04 for optimum scatterometry.

30. The instrument of claim 28 wherein the measurement system includes a pinhole aperture associated with the light collector receiving light from the wafer, with the objective lens imaging light traveling in opposite directions, the pinhole aperture maintaining a fixed optical relationship to the objective lens as the optical system moves.

31. The instrument of claim 26 wherein the light source is optically coupled to the optical measurement system via an optical fiber.

32. The instrument of claim 26 wherein the movable optical measurement system comprises a confocal microscope-based measurement system.

33. The instrument of claim 26 wherein the measurement system further includes an apodizer located near the objective aperture stop of the microscope-based system.

34. The instrument of claim 26 wherein illumination and collection paths of the microscope-based system separate at an inconel plate beamsplitter.

35. The instrument of claim 26 wherein the light beam incident on the wafer is substantially unpolarized and the optical measurement system is substantially polarization insensitive.

36. The instrument of claim 26 wherein the wafer handler of the process tool and the wafer support in the wafer measurement station provide an unspecified wafer orientation relative to the optical measurement system.

37. The instrument of claim 26 wherein the measurement station includes an optical absorber positioned to one side of the wafer support to provide a reference zero reflectance measure for bright background measurement.

38. The instrument of claim 26 wherein the measure of patterned features obtained by the data processor includes at least one dimension of lateral or vertical geometric structure of features on the wafer.

39. The instrument of claim 38 wherein the measure of patterned features include line width and profile of features of the wafer.

40. A wafer measurement method for cooperative use with a wafer process tool of the type having a wafer handler associated with a cassette of wafers, comprising:
within the wafer process tool after completion of any of one or more process steps carried out in processing stations of the process tool, receiving in an integrated measuring station of the process tool a wafer from a wafer handler associated with the process tool without first transferring wafers out of the process tool to another cassette or cassette loading station, and depositing the wafer at an unspecified orientation in the measurement station relative to a moveable optical measurement system;
moving an optical measurement system to a plurality of locations over the wafer;
directing a beam of light normally onto the wafer surface as a light spot at each of said plurality of locations, the light spot characterized by a spot size that is larger at the wafer surface than a periodicity of pattern features on the wafer;
detecting light reflected from the wafer surface to obtain data for an optical characteristic of surface pattern features of the wafer at said plurality of locations; and
analyzing the optical characteristic data using a scattering model of possible periodic structures on a wafer to obtain a measure of critical dimensions of the surface pattern features on the wafer.

41. The method of claim 40 further defined by sequentially measuring reflectance data for a plurality wafers received from the wafer process tool.

42. A method of measuring a wafer within a wafer process tool, comprising:
transferring a wafer robotically from a process station of the process tool to a measurement station of the process tool;
positioning a measurement spot of an optical head of a measurement instrument within the measurement station over a first location of the wafer;
rotating the wafer and translating the optical head to position the measurement spot over a second location of the wafer;
repeating the wafer rotation and optical head translation to successively position the measurement spot over different locations of the wafer; and
measuring an optical characteristic of the wafer at each of the successive measurement locations.
